(19) United States
(12) Patent Application Publication
(10) Pub. No.: US 2025/0305751 A1
(43) Pub. Date: Oct. 2, 2025

(54) REFRIGERATOR COMPRISING TRANSPARENT DOOR WITH ATTACHED FILM HEATER

(71) Applicant: SAMSUNG ELECTRONICS CO., LTD., Suwon-si (KR)

(72) Inventors: Sangky JE, Suwon-si (KR); Sangyun GIM, Suwon-si (KR)

(73) Assignee: SAMSUNG ELECTRONICS CO., LTD., Suwon-si (KR)

(21) Appl. No.: 19/232,296

(22) Filed: Jun. 9, 2025

Related U.S. Application Data
(63) Continuation of application No. PCT/KR2023/020916, filed on Dec. 18, 2023.

(30) Foreign Application Priority Data
Feb. 9, 2023 (KR) 10-2023-0017262
Mar. 3, 2023 (KR) 10-2023-0028758

(51) Int. Cl. F25D 21/04; F25D 21/00; F25D 21/02; H05B 3/84

(52) U.S. Cl. CPC F25D 21/04; F25D 21/006; F25D 21/02; H05B 3/84

(57) ABSTRACT

A refrigerator including: a main body including a storage compartment; a door coupled to the main body and configured to open and close the storage compartment, at least a portion of the door being transparent; and a film heater attached to the door. The film heater includes a heating-element heating wire configured to emit heat, and the heating-element heating wire is within 1 mm to 7 mm from an end of the film heater.

### CROSS-REFERENCE TO RELATED APPLICATIONS

This application is a continuation of International Application No. PCT/KR2023/020916, filed on Dec. 18, 2023, which is based on and claims priority to Korean Patent Application No. 10-2023-0017262, filed on Feb. 9, 2023, in the Korean Intellectual Property Office, and Korean Patent Application No. 10-2023-0028758, filed on Mar. 3, 2023, in the Korean Intellectual Property Office, the disclosures of which are incorporated by reference herein in their entireties.

### BACKGROUND

### 1. Field

The present disclosure relates to a refrigerator including a film heater, in which, when a door of the refrigerator includes a transparent door, dew formation may be prevented by heating a portion of the transparent door.

### 2. Description of Related Art

Refrigerators are home appliances that include a storage compartment that stores food and a cold air supply device including a compressor that supplies cold air to the storage compartment to keep food fresh. Recently, as the sizes and functions of refrigerators have diversified, refrigerators in which upper and lower doors are separately opened and closed, as well as refrigerators including side-by-side doors have been developed. In addition, as well as having a traditional food storage purpose, refrigerators are evolving into complex devices with additional functions, and a representative additional function is a communication function as in an Internet of things (IoT) device.

### SUMMARY

A refrigerator including: a main body including a storage compartment; a door coupled to the main body and configured to open and close the storage compartment, at least a portion of the door being transparent; and a film heater attached to the door. The film heater includes a heating-element heating wire configured to emit heat, and the heating-element heating wire is within 1 mm to 7 mm from an end of the film heater.

The door may be a transparent glass door or a transparent plastic door.

The film heater may be attached to an edge of the door.

The film heater may be attached to the edge of the door such that the heating-element heating wire directly contacts the edge of the door.

An amount of the heating-element heating wire of the film heater may be more densely arranged in an area of the edge of the door in a location in which a humidity level of the door is high than in a location in which the humidity level of the door is low.

The refrigerator may further include: a humidity sensor configured to sense the humidity level of the door; and a processor configured to control the heating-element heating wire of the film heater in a state in which the humidity level of at least the portion of the door sensed by the humidity sensor is greater than a threshold level.

The processor may be further configured to control a magnitude of electric energy supplied to the film heater according to the humidity level sensed by the humidity sensor.

The film heater may include a first insulating film on a first surface of the film heater.

The first insulating film may include an adhesive material configured to adhere to the door.

The film heater may include a second insulating film on a second surface of the film heater opposite to the first surface. The heating-element heating wire may be between the first insulating film and the second insulating film.

A thickness of the film heater may be 600 micrometers or less.

The heating-element heating wire may be arranged on the door in a left and right zigzag shape vertically to a longitudinal direction of the edge of the door, and an amount of the heating-element heating wire may be more densely arranged in an area in which a humidity level of the door is high than in an area in which the humidity level of the door is low.

The heating-element heating wire may be arranged on a frame of the door in a longitudinal direction of the edge of the door, and an amount of the heating-element heating wire may be more densely arranged in an area in which a humidity level of the door is high than in an area in which the humidity level of the door is low.

The heating-element heating wire may be within 4 mm to 5 mm from the end of the film heater.

### BRIEF DESCRIPTION OF DRAWINGS

The above and other aspects, features, and advantages of certain embodiments of the present disclosure will be more apparent from the following description taken in conjunction with the accompanying drawings, in which:

FIG. 1 is a diagram of a refrigerator including a transparent door, according to one or more embodiments of the present disclosure;

FIG. 2A is a diagram illustrating a state where a cord heater is installed in a refrigerator door, according to one or more embodiments of the present disclosure;

FIG. 2B is a diagram illustrating a structure of a cord heater according to one or more embodiments of the present disclosure;

FIG. 2C is a cross-sectional view of a cord heater according to one or more embodiments of the present disclosure;

FIG. 3 is a cross-sectional view illustrating a state where a cord heater is attached to a back surface of a transparent door, according to one or more embodiments of the present disclosure;

FIG. 4A is a diagram illustrating an example in which aluminum foil is lifted off when a cord heater is installed, according to one or more embodiments of the present disclosure;

FIG. 4B is a diagram illustrating penetration of a foam liquid between lifted areas when a cord heater is installed, according to one or more embodiments of the present disclosure;

FIG. 5A is a diagram illustrating a configuration of a film heater according to one or more embodiments of the present disclosure;

FIG. 5B is a diagram illustrating a configuration of a film heater according to one or more embodiments of the present disclosure;

FIG. 6 is a diagram illustrating an end terminal of a film heater according to one or more embodiments of the present disclosure;

FIG. 7A is a diagram illustrating a state where a film heater is mounted on a transparent door, according to one or more embodiments of the present disclosure;

FIG. 7B is a diagram illustrating a state where a heating element of a film heater is arranged to alternate in zigzags left and right and is attached onto a transparent door, according to one or more embodiments of the present disclosure;

FIG. 7C is a diagram illustrating a state where a heating element of a film heater is arranged parallel to a longitudinal direction of a transparent door and is attached to the transparent door, according to one or more embodiments of the present disclosure;

FIG. 7D is a diagram illustrating a state where a heating element of a film heater is arranged to alternate in zigzags left and right and is attached to a transparent door with different print densities, according to one or more embodiments of the present disclosure;

FIG. 7E is a diagram illustrating a state where a film heater installed in a transparent door has different densities of a heating element depending on a position thereof, according to one or more embodiments of the present disclosure;

FIG. 8 is a diagram illustrating that areas are divided to provide different densities for each area when a film heater is arranged on a transparent door, according to one or more embodiments of the present disclosure; and

FIG. 9 is a block diagram of a refrigerator according to one or more embodiments of the present disclosure.

### DETAILED DESCRIPTION

The terms as used herein are briefly described, and one or more embodiments of the present disclosure is described in detail.

As for the terms as used herein, common terms that are currently widely used are selected as much as possible while taking into account functions in one or more embodiments of the present disclosure. However, the terms may vary depending on the intention of those of ordinary skill in the art, precedents, the emergence of new technology, and the like. Also, in a specific case, there are also terms arbitrarily selected by the applicant. In this case, the meaning of the terms will be described in detail in the description of the embodiment of the present disclosure. Therefore, the terms as used herein should be defined based on the meaning of the terms and the description throughout the present disclosure rather than simply the names of the terms.

Throughout the present disclosure, the expression “a portion includes a certain element” means that a portion further includes other elements rather than excludes other elements unless otherwise stated. Also, the terms such as “unit” and “module” as used herein refer to units that process at least one function or operation, and may be implemented as hardware, software, or a combination of hardware and software.

In the present document, the expressions “A or B,” “at least one of A and B,” “at least one of A or B,” “A, B, or C,” “at least one of A, B, and C,” and “at least one of A, B, or C” may include any one of the items listed in the corresponding expression or all possible combinations thereof.

The term “and/or” as used herein includes a combination of a plurality of related recited elements or any one of a plurality of related recited elements.

The terms “first,” “second,” etc. as used herein may be only used to distinguish one element from another and do not limit the elements in any other aspects (e.g., importance or order).

When a certain (e.g., first) element is referred to as being “coupled” or “connected” to another (e.g., second) element with or without the terms “functionally” or “communicatively,” it means that the certain element may be coupled or connected to the other element directly (e.g., by wire) or wirelessly or through a third element.

It will be understood that when an element is referred to as being “connected to,” “coupled to,” “supported to,” or “in contact with” another element, the element may be “directly connected to, coupled to, supported to, or in contact with” the other element or may be “indirectly connected to, coupled to, supported to, or in contact with” the other element through a third element.

It will be understood that when an element is referred to as being located “on” another element, the element may be in contact with the other element, and another element may also be present between the two elements.

A refrigerator according to various embodiments may include a main body.

The “main body” may include an inner case, an outer case arranged outside the inner case, and a heat insulator provided between the inner case and the outer case.

The “inner case” may include a case, a plate, a panel, or a liner, which forms a storage compartment. The inner case may be formed as a single body or may be formed by assembling a plurality of plates. The “outer case” may form the exterior of the main body, and may be coupled to the outer side of the inner case so that the heat insulator is arranged between the inner case and the outer case.

The “heat insulator” may insulate the inside and the outside of a storage compartment so that the inside of the storage compartment is maintained at a set appropriate temperature, without being affected by an environment outside the storage compartment. According to one or more embodiments, the heat insulator may include a foam heat insulator. The foam heat insulator may be molded by fixing the inner case and the outer case to each other with a jig or the like and injecting and foaming urethane foam, in which polyurethane and a foaming agent are mixed, between the inner case and the outer case.

According to one or more embodiments of the present disclosure, the heat insulator may include, in addition to the foam heat insulator, a vacuum heat insulator, or the heat insulator may include only a vacuum heat insulator instead of the foam heat insulator. The vacuum heat insulator may include a core material and an envelope that accommodates the core material and seals the interior with a vacuum or a pressure close to vacuum. The vacuum heat insulator may further include an adsorbent that adsorbs gases and moisture to stably maintain a vacuum state.

However, the heat insulator is not limited to the foam heat insulator or the vacuum heat insulator and may include various materials usable for heat insulation.

A refrigerator according to various embodiments may include a storage compartment provided inside a main body so as to store food.

The “storage compartment” may include a space defined by the inner case. The storage compartment may further include an inner case that defines the space. The storage compartment may be formed so that at least one side of the storage compartment is opened so as to put food in the storage compartment and take out food from the storage compartment. The storage compartment may be provided to store “food.” Food may include food and drink that may be eaten or drunk, and specifically, may include meat, fish, seafood, fruits, vegetables, water, ice, beverages, kimchi, or alcoholic beverages, such as wine. However, in addition to food, medicines and cosmetics may also be stored in the storage compartment, and there are no restrictions on items that may be stored in the storage compartment.

The refrigerator may include one or more storage compartments. When two or more storage compartments are formed in the refrigerator, the respective storage compartments may have different purposes and may be maintained at different temperatures. To this end, the storage compartments may be partitioned from each other by partition walls each including a heat insulator. According to one or more embodiments, the partition wall may be a portion of the main body. According to one or more embodiments, the partition wall may be a separate partition that is provided separately from the main body and assembled to the main body.

The storage compartment may be maintained in an appropriate temperature range depending on the purpose, and may include a “refrigerating compartment,” a “freezing compartment,” or a “changeable temperature compartment,” which is divided according to the purpose and/or the temperature range. The refrigerating compartment may be maintained at a temperature suitable for keeping food refrigerated, and the freezing compartment may be maintained at a temperature suitable for keeping food frozen. The “refrigerating” may refer to cooling food to the extent that the food does not freeze. As an example, the refrigerating compartment may be maintained in a range of about 0° C. to about 7° C. The “freezing” may refer to freezing or cooling food to remain frozen. As an example, the freezing compartment may be maintained in a range of about −20° C. to about −1° C. The changeable temperature compartment may be used as either a refrigerating compartment or a freezing compartment according to or regardless of a user's choice. According to one or more embodiments, one storage compartment may be provided so that a portion of the storage compartment is used as a refrigerating compartment and the other portion of the storage compartment is used as a freezing compartment.

The storage compartment may also be referred to as various names, such as a “vegetable compartment,” a “fresh compartment,” a “cooling compartment,” and an “ice making compartment,” in addition to the “refrigerating compartment,” the “freezing compartment,” and the “changeable temperature compartment.” The terms “refrigerating compartment,” “freezing compartment,” and “changeable temperature compartment” as used herein should be understood as encompassing the storage compartments having the corresponding purposes and temperature ranges.

The refrigerator according to various embodiments may include a door configured to open and close one open side of the storage compartment.

The “door” may be configured to close the storage compartment when the door is closed. Like the main body, the door may include a heat insulator to insulate the storage compartment when the door is closed.

The refrigerator according to various embodiments may include a cold air supply device provided to supply cold air to the storage compartment.

The “cold air supply device” may include a machine, an appliance, an electronic device, and/or a combination system thereof, which are capable of generating and guiding cold air so as to cool the storage compartment.

According to one or more embodiments, the cold air supply device may generate cold air through a refrigeration cycle including compression, condensation, expansion, and evaporation of a refrigerant. To this end, the cold air supply device may include a refrigeration cycle device having a compressor, a condenser, an expansion device, and an evaporator, which are capable of driving a refrigeration cycle.

The refrigerator according to various embodiments may include a machine compartment in which at least some parts belonging to the cold air supply device are provided.

The “machine compartment” may be partitioned and insulated from the storage compartment so as to prevent heat generated from parts provided in the machine compartment from being transferred to the storage compartment. The inside of the machine compartment may be configured to communicate with the outside of the main body so as to dissipate heat from parts provided inside the machine compartment.

The terms ‘front surface,’ rear surface,′ ‘top surface,’ ‘bottom surface,’ ‘side surface,’ ‘left side,’ ‘right side,’ ‘upper portion,’ ‘lower portion,’ etc. used in the present disclosure are defined based on the drawings and should be understood to mean relative positions by these terms, and should not be interpreted to limit the shape and position of each component.

Hereinafter, one or more embodiments of the present disclosure will be described in detail with reference to the accompanying drawings, so that those of ordinary skill in the art may easily carry out the present disclosure. However, the present disclosure may be implemented in various different forms and is not limited to the embodiment described herein. In order to clearly explain one or more embodiments of the present disclosure, parts irrelevant to the description are omitted in the drawings, and the same or similar reference numerals are assigned to the same or similar parts throughout the present disclosure.

Throughout the present disclosure, the refrigerator may be used interchangeably with the term “refrigerator device” or “refrigerator home appliance.”

The refrigerator 1000 is a type of home appliance that supplies cold air generated by a compressor to a storage compartment so that various foods may be preserved for a long time. In addition to the long-term food preservation function, various functions are added to the refrigerator, and the most representative function is a communication function that enables an Internet of things (IoT) network to be configured. In addition, recently, a function that allows a user to check the inside of the refrigerator without opening doors, including transparent doors that allow a user to see inside, has been added to the refrigerator doors, which enhances the aesthetic appeal of design.

A refrigerator including a transparent door with an attached film heater, according to one or more embodiments of the present disclosure, may include a main body having a storage compartment, and a transparent door coupled to the main body to open and close the storage compartment, wherein at least a portion of the transparent door may be transparent. The refrigerator including the transparent door with the attached film heater, according to one or more embodiments of the present disclosure, may include a film heater attached onto the transparent door. In the refrigerator including the transparent door with the attached film heater, according to one or more embodiments of the present disclosure, the film heater may include a heating-element heating wire configured to emit heat. In the refrigerator including the transparent door with the attached film heater, according to one or more embodiments of the present disclosure, the heating-element heating wire may be located within a certain distance of 1 mm to 7 mm from an end of the film heater.

According to one or more embodiments, the transparent door may include a transparent glass door made of a glass material or a transparent plastic door made of a plastic material.

According to one or more embodiments, the film heater may be attached to an edge of the transparent door.

According to one or more embodiments, the film heater may be attached to the edge of the transparent door so that the heating-element heating wire may be in direct contact with the edge of the transparent door.

According to one or more embodiments, the heating-element heating wire of the film heater may be arranged relatively more densely in an area of the edge of the transparent door where a humidity level of the transparent door is high.

According to one or more embodiments, the refrigerator may further include a humidity sensor configured to sense the humidity level of the transparent door, and a processor configured to operate the heating-element heating wire of the film heater when a humidity of at least a portion of the transparent door sensed by the humidity sensor rises above a certain level.

According to one or more embodiments, the processor may be further configured to control a magnitude of electric energy supplied to the film heater according to the humidity level sensed by the humidity sensor.

According to one or more embodiments, the film heater may include an insulating film on a first surface thereof.

According to one or more embodiments, the insulating film on the first surface may include an adhesive material so that the insulating film is attached to the transparent door.

According to one or more embodiments, the film heater may include an insulating film on a second surface opposite to the first surface with the heating-element heating wire therebetween.

According to one or more embodiments, a thickness of the film heater may be 600 micrometers or less.

According to one or more embodiments, the heating-element heating wire may be arranged on the transparent door in a left and right zigzag shape vertically to a longitudinal direction of the edge of the transparent door. According to one or more embodiments, the heating-element heating wire may be arranged at a relatively high density in an area where the humidity of the transparent door is high.

According to one or more embodiments, the heating-element heating wire may be arranged on a frame of the transparent door in a longitudinal direction of the edge of the transparent door. According to one or more embodiments, the heating-element heating wire may be arranged at a relatively high density in an area where the humidity of the transparent door is high.

According to one or more embodiments, the certain distance from the end of the film heater may be 4 mm to 5 mm.

In general, refrigerators are home appliances that include a storage compartment that stores food and a cold air supply device that supplies cold air to the storage compartment, so that food is kept fresh. The types of refrigerators may be classified according to the shapes of storage compartments and doors.

There are a top mounted freezer (TMP)-type refrigerator in which a storage compartment is divided vertically by a horizontal partition wall so that a freezing compartment is formed on the top and a refrigerating compartment is formed on the bottom, and a bottom mounted freezer (BMF)-type refrigerator in which a refrigerating compartment is formed on the top and a freezing compartment is formed on the bottom.

In addition, there is a side-by-side (SBS)-type refrigerator in which a storage compartment is divided left and right by a vertical partition wall so that a freezing compartment is formed on one side and a refrigerating compartment is formed on the other side, and there is a French door refrigerator (FDR)-type refrigerator in which a storage compartment is divided up and down by a horizontal partition wall so that a refrigerating compartment is formed on the upper side, a freezing compartment is formed on the lower side, and the refrigerating compartment on the upper side is opened and closed by a pair of doors.

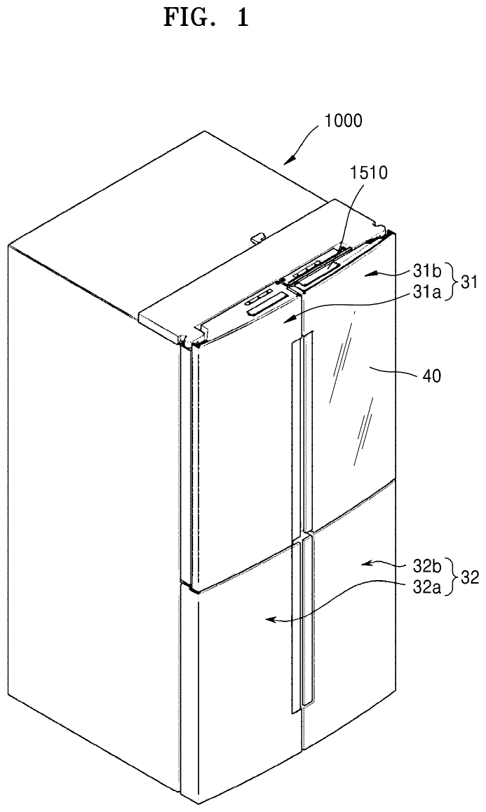

FIG. 1 illustrates an exterior of a refrigerator according to one or more embodiments of the present disclosure, with doors in a closed state.

Referring to FIG. 1, a refrigerator 1000 is illustrated as having SBS-type doors as an example, but the present disclosure is not limited thereto. The refrigerator 1000 including a transparent door, according to one or more embodiments of the present disclosure, may include any refrigerator including a ‘door,’ such as a mini-bar, a one-door refrigerator, or a two-door refrigerator.

The refrigerator 1000 includes a storage compartment formed by vertical partition inside a main body, doors 31 and 32 that open and close the storage compartment, and a cold air supply device that supplies cold air to the storage compartment. The cold air supply device may include a compressor, a condenser, an expansion valve, an evaporator, a blower fan, a cold air duct, and the like. A machine compartment, in which the compressor that compresses a refrigerant and the condenser that condenses the compressed refrigerant are installed, may be provided at the lower rear side of the refrigerator 1000. The cold air supply device may generate cold air by using a cooling circulation cycle that compresses, condenses, expands, and evaporates the refrigerant.

The refrigerator 1000 according to FIG. 1 may include an upper door 31 and a lower door 32. The upper door 31 may include an upper left door 31a and an upper right door 31b. The lower door 32 may include a lower left door 32a and a lower right door 32b. It may be confirmed that the upper right door 31b of the refrigerator 1000 according to one or more embodiments of the present disclosure is a transparent door 40 that is completely or at least partially transparent. Because which door to select the transparent door 40 is the choice of a manufacturer, any of the upper left door 31a, the upper right door 31b, the lower left door 32a, and the lower right door 32b may be a transparent door. Typically, manufacturers may choose to make one of the upper doors 31 a transparent door based on design aesthetics, but the present disclosure is not limited thereto.

The transparent door 40 allows the user of the refrigerator 1000 to see the inside of the refrigerator 1000 without opening the door. A transparent plate of the transparent door 40 according to one or more embodiments of the present disclosure may be made of glass or plastic.

Because the inside of the refrigerator 1000 is lower than the temperature surrounding the refrigerator, dew may form in areas where a temperature difference occurs due to the opening of the door. In particular, in the case of including the transparent door 40 that allows the inside of the refrigerator to be checked without opening the door, a function of removing dew formed on the transparent door 40 is required because the inside of the refrigerator may not be visible due to dew formed on the door. To prevent the dew formation, a heater may be installed in the area where the temperature difference occurs.

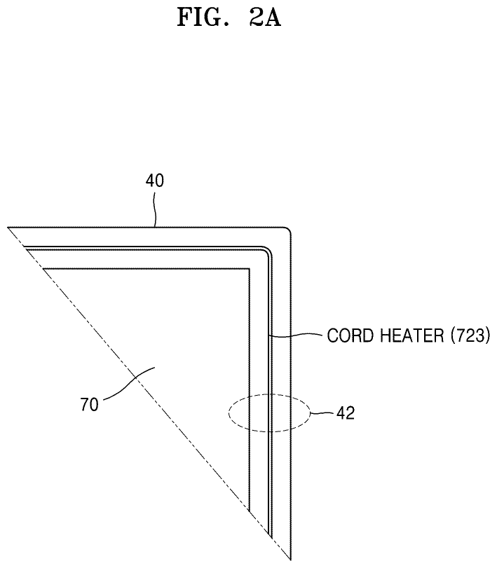

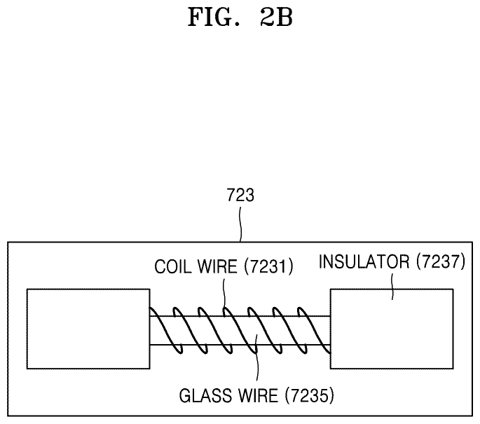

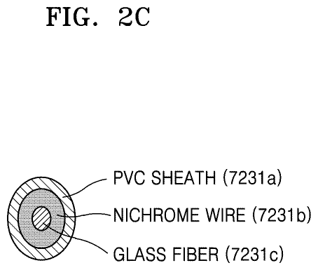

Depending on the edge position of the transparent door 40, dew may form on the transparent door 40 due to a temperature difference with external air. Specifically, dew may form on the front or back surface of the transparent door 40. A heater may be installed on the back surface of the transparent door 40 so as to remove dew formation. The heater may be a cord heater or a film heater. According to one or more embodiments of the present disclosure, the film heater may be installed in the transparent door 40. A phenomenon that occurs when the cord heater is installed is described below with reference to FIGS. 2A to 2C. The film heater may be connected to a power supply unit provided inside the main body 10 of the refrigerator 1000 and may receive electric current from the power supply unit. The film heater may include a heating element therein, and the heating element may generate heat through electric current supplied from the power supply unit. When the film heater generates heat, the temperature around the transparent door 40 to which the film heater is attached may increase, and thus, dew formation on the transparent door 40 may be prevented.

Because the film heater has a film form, the film heater may be thin and attached to the transparent door 40, compared to the cord heater. The film heater may be attached to the inner back surface of the transparent door 40. An adhesive surface having adhesive strength may be provided on one surface of the film heater. The adhesive surface may include a double-sided tape, but the present disclosure is not limited thereto. The film heater may be attached to the back surface of the transparent door 40, without a separate fastening mechanism, by using the adhesive force of the adhesive surface.

In one or more embodiments, the refrigerator 1000 may include a humidity sensor 1510 capable of sensing humidity inside the upper door 31 and/or the lower door 32.

FIG. 2A is a diagram illustrating a state where a cord heater is installed in a refrigerator door, according to one or more embodiments of the present disclosure.

Referring to FIG. 2A, it is illustrated that a cord heater 723 is installed on a back surface 42 of a transparent door 40. Because a heating element of the cord heater 723 has a round shape like an electric wire, the cord heater 723 may not be installed to be flat when installed on the back surface 42 of the transparent door 40.

FIG. 2B is a diagram illustrating a structure of a cord heater according to one or more embodiments of the present disclosure.

As seen in FIG. 2B, a cord heater 723 has a shape similar to an electric wire with a heating wire structure. Referring to FIG. 2B, the structure of the cord heater 723 is formed by winding a coil wire 7231 around a glass yarn 7235. Both ends of the cord heater 723 may be surrounded by an insulator 7237 made of a polyvinyl chloride (PVC) material for insulation.

FIG. 2C is a cross-sectional view of a cord heater according to one or more embodiments of the present disclosure.

Referring to FIG. 2C, a cord heater 723 is surrounded by a PVC sheath 7231a for insulation on the outermost side, and a nichrome wire 7231b is provided therein as a conductor that allows electric current to flow. Glass fiber 7231c may be provided at the innermost side of the nichrome wire 7231b.

When the cord heater 723 according to FIGS. 2B and 2C is installed on the back surface 42 of the transparent door 40 as in FIG. 2A, the structure of the cord heater 723 allows for local attachment and fixation. In this case, the heating wire may be lifted, which may cause difficulty in attachment and may also result in poor heat transfer.

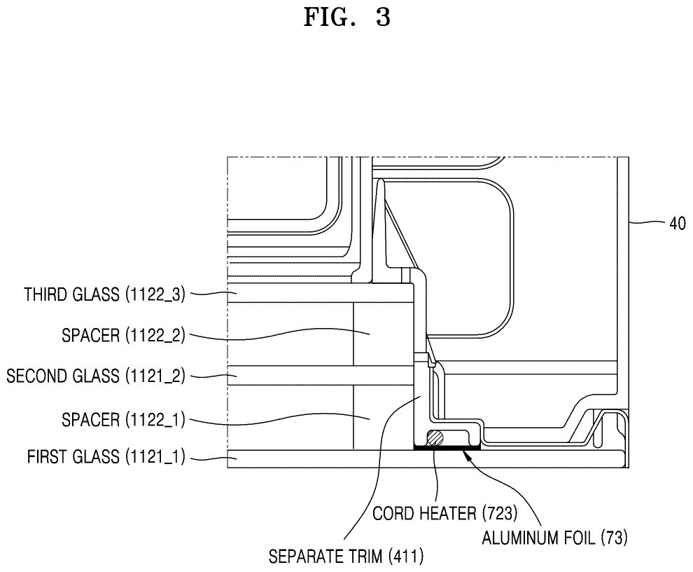

FIG. 3 is a cross-sectional view illustrating a state where a cord heater is attached to a back surface of a transparent door, according to one or more embodiments of the present disclosure.

To prevent dew formation on the transparent door 40 of the refrigerator 1000, a cord heater 723 may be installed on a back surface 42 of a transparent door 40. The transparent door 40 is not necessarily limited thereto. As illustrated in FIG. 3, the transparent door 40 may be manufactured as a double-glass structure in which a spacer 1122_1 is installed between a first glass 1121_1 and a second glass 1121_2 and an additional spacer 1122_2 is installed between the second glass 1121_2 and a third glass 1122_3. When manufacturing the transparent door 40, the manufacturer may install the cord heater 723 between a separate trim 411 and aluminum foil 73, and the aluminum foil 73 may come into close contact with the bottom of the transparent door 40. However, the cord heater 723 has a circular cross-sectional shape, which may cause the aluminum foil 73 to be lifted off. When the aluminum foil 73 is lifted off, the foaming liquid may penetrate between the cord heater 723 and the aluminum foil 73, which reduces heating efficiency and causes a deterioration in the quality of the transparent door 40.

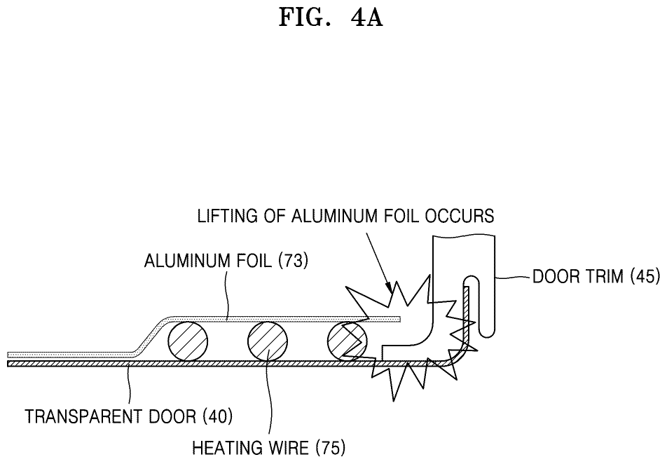

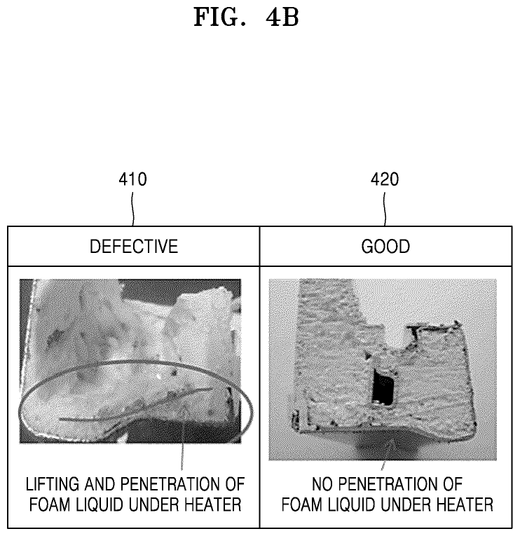

FIG. 4A is a diagram illustrating an example in which aluminum foil is lifted off when a cord heater is installed, according to one or more embodiments of the present disclosure.

Referring to FIG. 4A, it is illustrated that the aluminum foil 73 is lifted off between a door trim 45 and a transparent door 40 by a heating wire 75 of a cord heater 723.

FIG. 4B is a diagram illustrating penetration of a foam liquid between lifted areas when a cord heater is installed, according to one or more embodiments of the present disclosure.

Referring to FIG. 4B, 410 shows that a foaming liquid penetrates under a cord heater 723 when the cord heater 723 is installed on a transparent door 40. In contrast, 420 on the right side of FIG. 4B shows that there is no penetration of the foam liquid when the film heater is attached to the transparent door 40. One or more embodiments in which the film heater is attached to the transparent door 40 is described below.

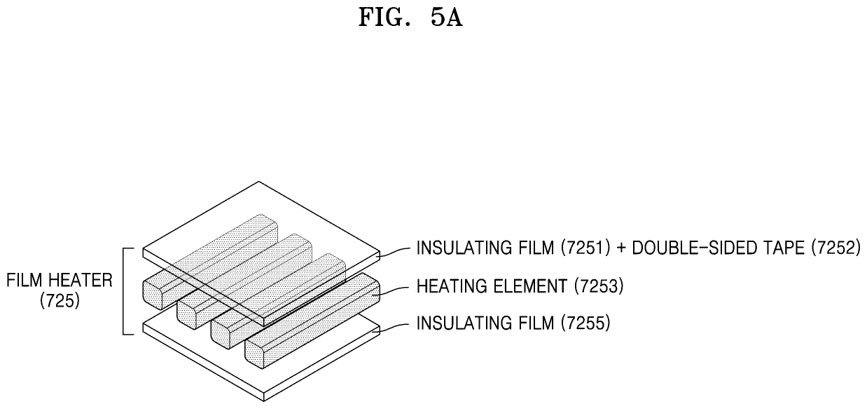

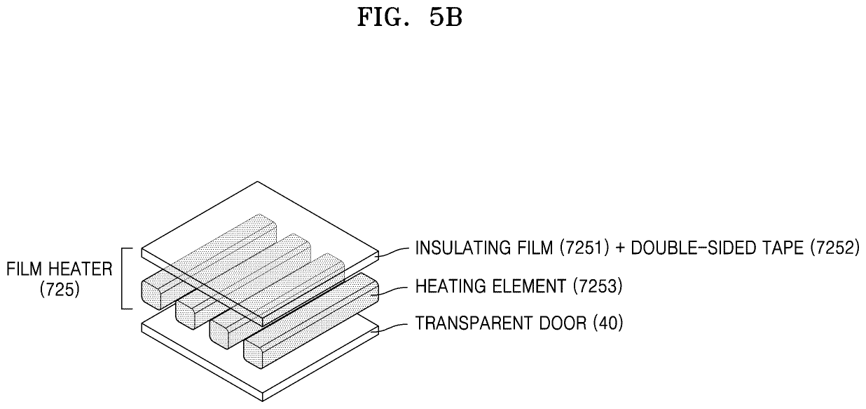

FIG. 5A is a diagram illustrating a configuration of a film heater according to one or more embodiments of the present disclosure.

Referring to FIG. 5A, an upper portion of a film heater 725 according to one or more embodiments of the present disclosure may include an insulating film 7251 and a double-sided tape 7252 including an adhesive so that the insulating film 7251 is directly attached to a transparent door 40. The insulating film 7251 may be a polyethylene terephthalate (PET) film or an ethylene-vinyl acetate copolymer (EVA) film. The center of the film heater 725 may include a heating element 7253 that is capable of generating heat. The heating element 7253 may include a silver nano (Ag nano) ink component, but the present disclosure is not limited thereto. The heating element 7253 may be located within 1 mm to 7 mm from the side surface of the film heater 725. Preferably, the heating element 7253 may be located within 4 mm to 5 mm from the side surface of the film heater 725. The heating element 7253 may be located within a distance (1 mm to 4 mm) less than 4 mm from the side surface of the film heater 725. However, to ensure insulation of the heating element 7253, the heating element 7253 is located at a distance of about 4 mm to about 5 mm from the end of the side surface of the film heater 725. As the heating element 7253 is located closer to the side surface of the film heater 725, the heat efficiency for removing dew formed on the transparent door 40 may increase. The lowermost portion of the film heater 725 may include an insulating film 7255 for insulation. The insulating film 7255 may be a PET film. When the heating wire of the transparent door 40 is configured with the film heater 725 as illustrated in FIG. 5A, the insulation thickness between the heating wire and the insulating film 7251 of the film heater 725 is thin, so that the heat transfer efficiency from the film heater 725 to the surface of the transparent door 40 may be maximized.

In addition, the film heater 725 according to one or more embodiments of the present disclosure may have a structure such as a sheet having a thickness (e.g., 300 μm or less) less than 600 μm. When the film heater 725 having the sheet structure is attached to the transparent door 40, the lifting phenomenon is minimized. Accordingly, there is no concern about the penetration of the foam liquid into the inside, and the problem of reduced heating efficiency does not occur. The film heater 725 having the sheet structure has a larger contact area with the transparent door 40 than the cord heater 723, and this enables heat to be uniformly transferred to the transparent door 40 when the heating element 7253 generates heat.

In the film heater 725 according to one or more embodiments of the present disclosure, the adhesive surface of the double-sided tape 7252 may be directly attached to the transparent door 40. The film heater 725 may be attached to the outer edge of the transparent door 40. In this manner, the film heater 725 may be attached to the transparent door 40 as close as possible to the transparent plate of the transparent door 40 on which dew may form.

FIG. 5B is a diagram illustrating a configuration of a film heater according to one or more embodiments of the present disclosure. Referring to FIG. 5B, an upper portion of a film heater 725 according to one or more embodiments of the present disclosure may include a double-sided tape 7252 including an adhesive so that the film heater 725 is attached to a lower transparent door 40 together with an insulating film 7251. The insulating film 7251 may be a PET film or an EVA film. The film heater 725 may include a heating element 7253, which is capable of generating heat, on a layer below the double-sided tape 7252. The heating element 7253 may include a silver nano ink component, but the present disclosure is not limited thereto. The heating element 7253 may be located within 1 mm to 7 mm from the side of the film heater 725. Preferably, to ensure an insulation distance, the heating element 7253 may be located within 4 mm to 5 mm from the side of the film heater 725. Unlike the case of FIG. 5A, the film heater 725 according to FIG. 5B may be manufactured so that the transparent door 40 is located directly below the heating element 7253. In this manner, the film heater 725 may be directly attached on the transparent door 40. Because the insulating film 7251 is not included at the lower end of the heating element 7253, the film heater 725 according to FIG. 5B may have a more advantageous heat efficiency than the film heater 725 according to FIG. 5A.

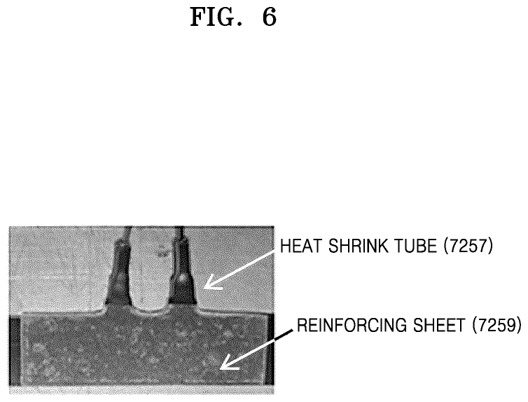

FIG. 6 is a diagram illustrating an end terminal of a film heater according to one or more embodiments of the present disclosure.

An end terminal of a film heater 725 may be insulated with a heat shrink tube 7257, as illustrated in FIG. 6, and the end may be processed by employing a reinforcing sheet 7259. The heat shrink tube 7257 is a tube that has the property of shrinking when heated, and is used to insulate a conductor connection portion from the outside after soldering an end of a conductor or connecting the conductor like a ring, or to apply a pressure to the ring connection of the conductor. The end of the film heater 725 may be fixed through the heat shrink tube 7257.

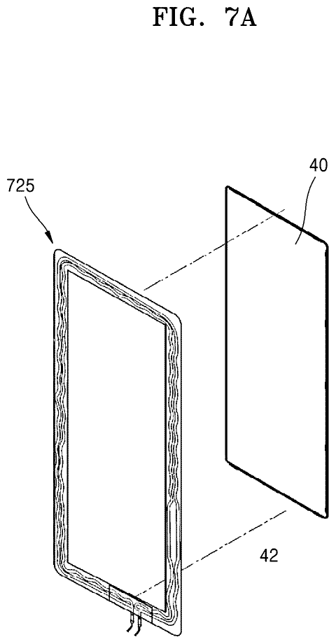

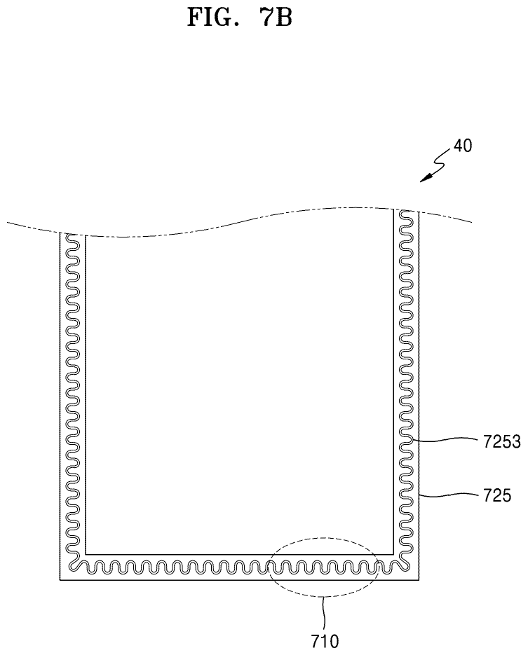

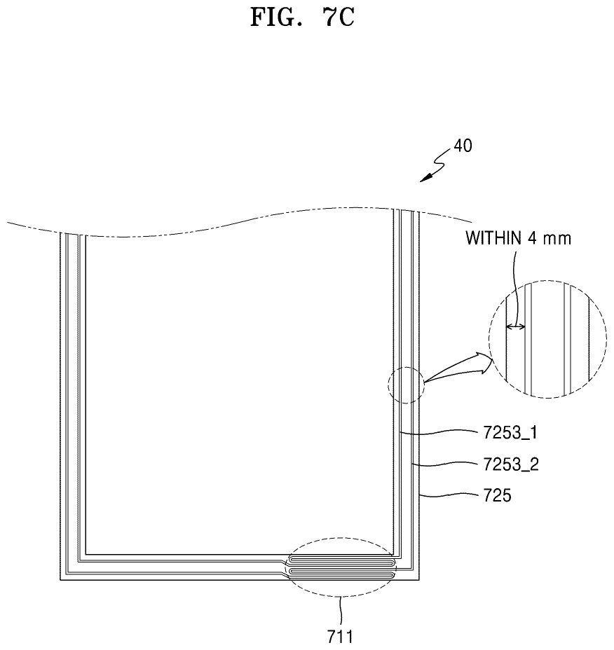

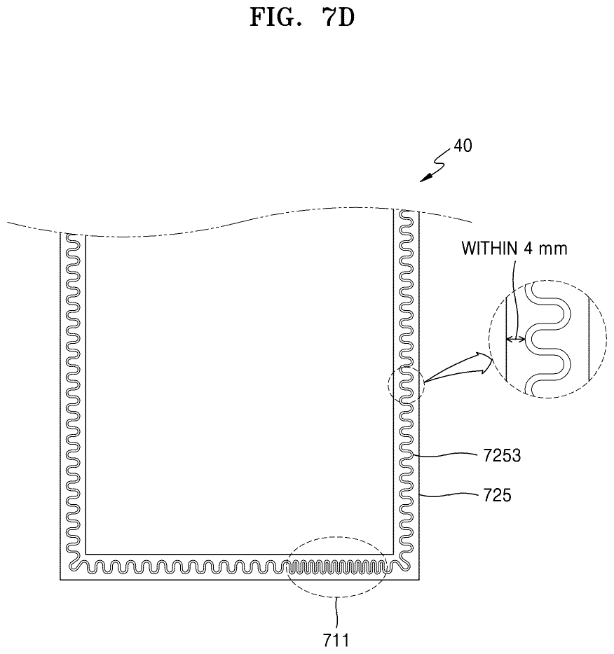

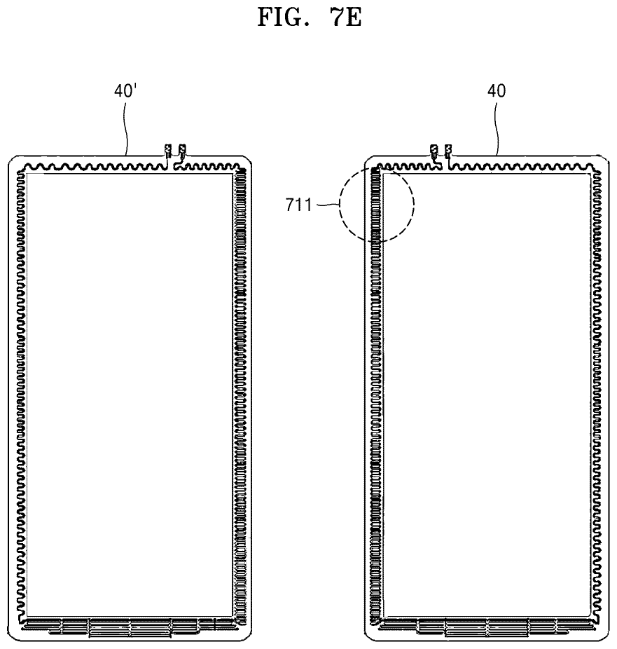

FIG. 7A is a diagram illustrating a state where the film heater is mounted on the transparent door, according to one or more embodiments of the present disclosure.

Referring to FIG. 7A, the film heater 725 may be manufactured to be attached onto the transparent door 40, but the present disclosure is not limited thereto. The film heater 725 may form a loop surrounding the transparent door 40 according to the shape of the transparent door 40, as illustrated in FIG. 7A, and may also be installed by being attached to only a portion of the edge of the transparent door 40.

FIG. 7B is a diagram illustrating a state where a heating element of a film heater is arranged to alternate in zigzags left and right and is attached onto a transparent door, according to one or more embodiments of the present disclosure.

Referring to FIG. 7B, as may be seen in 710, a heating element 7253 of a film heater 725 may be arranged in a zigzag shape perpendicular to a direction in which the film heater 725 surrounds a transparent door 40.

FIG. 7C is a diagram illustrating a state where a heating element of a film heater is arranged parallel to a longitudinal direction of a transparent door and is attached to a transparent door, according to one or more embodiments of the present disclosure.

Referring to FIG. 7C, it may be seen that a first line 7253_1 and a second line 7253_2 in a heating element 7253 of a film heater 725 according to one or more embodiments of the present disclosure are attached onto a transparent door 40 so as to be parallel to the longitudinal direction of the transparent door 40. The heating element 7253 may be located within 1 mm to 7 mm from the side end of the film heater 725. The first line 7253_1 and the second line 7253_2 in the heating element 7253 may be arranged in multiple lines on the film heater 725 at an area 711 where strong heat generation is required, and thus, so that the film heater 725 may be manufactured to have the highest heat generation intensity when the film heater 725 generates heat. That is, the local density of the heating element 7253 on the film heater 725 may vary depending on where the heat generation intensity of the film heater 725 should be high and where the heat generation intensity of the film heater 725 should be low. The method of varying the local density may effectively prevent dew formation while using power efficiently when dew formation occurs locally on the transparent door 40.

FIG. 7D is a diagram illustrating a state where a heating element of a film heater is arranged to alternate in zigzags left and right and is attached to a transparent door with different print densities, according to one or more embodiments of the present disclosure.

Referring to FIG. 7D, a heating element 7253 of a film heater 725 may be arranged in a zigzag shape perpendicular to a direction in which the film heater 725 surrounds a transparent door 40, as illustrated in FIG. 7B. However, an area 711 of the transparent door 40 is an area where a lot of dew forms. Therefore, the film heater 725 may be manufactured so that the density of the heating element 7253 is dense at the vicinity of the area 711. The heating element 7253 at the area 711 may increase the dew formation prevention strength at the vicinity of the area 711 by emitting stronger heat than other areas. In one or more embodiments, the heating element 7253 may be located within 1 mm to 7 mm from the side end of the film heater 725.

FIG. 7E is a diagram illustrating a state where a film heater installed in a transparent door has different densities of a heating element depending on a position thereof, according to one or more embodiments of the present disclosure.

Referring to FIG. 7E, a heating element 7253 of a film heater 725 arranged on a transparent door 40, according to one or more embodiments of the present disclosure, may be installed with different densities on the transparent door 40 depending on the frequency or intensity of dew formation on the transparent door 40. An area 711 is a place where dew is likely to form on the transparent door 40 and therefore the density of the heating element 7253 is also high. When the transparent door 40 illustrated on the right side of FIG. 7E is at least a portion of a right door of the refrigerator 1000, a left transparent door 40′ illustrated on the left side may be at least a portion of a left door of the refrigerator. Because the temperatures of the transparent doors 40 and 40′ may increase in the vicinity of an area where the door is opened and closed, the heating element 7253 may be manufactured with a high density in the area 711 near the door opening/closing area and at the lower end. The area setting for increasing the density of the heating element 7253 may be determined experimentally.

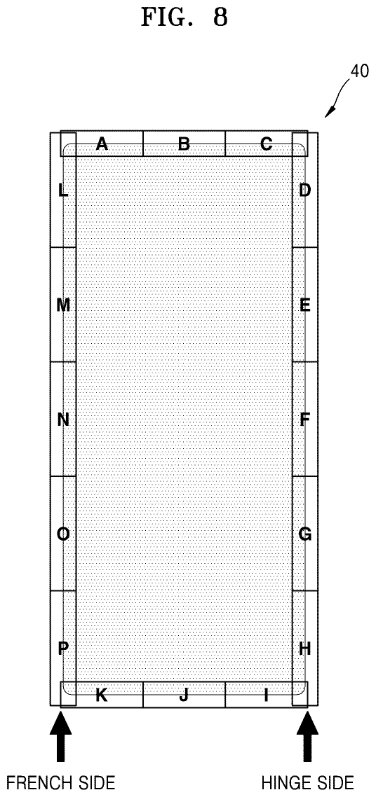

FIG. 8 is a diagram illustrating that areas are divided to provide different densities for each area when the film heater is arranged on the transparent door, according to one or more embodiments of the present disclosure.

Referring to FIG. 8, areas A to P are divided around a transparent door 40. For example, the upper portion may be divided into A, B, and C, the lower portion of the transparent door 40 may be divided into I, J, and K, the left side may be divided into L, M, N, O, and P, and the right side of the transparent door 40 may be divided into D, E, F, G, and H. In order to generate more power output in I, J, and K than in other areas because the power output below the transparent door 40 needs to be relatively high, more film heaters 725 may be attached to I, J, and K, or the density of the heating element 7253 of the film heater 725 may be increased.

Table 1 below shows the required electric energy and the corresponding length of the heating element 7253 by taking into account dew formation in each area.

TABLE 1

| Area | Required power | Length (mm) | Electric energy (W) |
|---|---|---|---|
| A | 0.25 | 163.7 | 0.25 |
| B | 0.37 | 241.5 | 0.37 |
| C | 0.37 | 241.7 | 0.37 |
| D | 1.17 | 763.05 | 1.17 |
| E | 1.08 | 705.8 | 1.08 |
| F | 0.90 | 587.5 | 0.90 |
| G | 1.13 | 738.0 | 1.13 |
| H | 1.30 | 847.3 | 1.30 |
| I | 1.25 | 816.9 | 1.25 |
| J | 2.18 | 1419.83 | 2.18 |
| K | 1.30 | 848.2 | 1.30 |
| L | 0.43 | 280.65 | 0.43 |
| M | 0.53 | 345.85 | 0.53 |
| N | 0.66 | 430.48 | 0.66 |
| O | 0.54 | 352.12 | 0.54 |
| P | 0.54 | 352.34 | 0.54 |
| Sum | 14 | 9134.11 | 14 |

As confirmed in Table 1 above, the length of the heating element 7253 is proportionally increased in the area with high requested electric energy in the areas A to P on the transparent door 40. However, to arrange the heating element 7253 in a long length within a limited area, the density at which the heating element 7253 is arranged has to be increased. As may be seen in Table 1 above, the longest area of the heating element 7253 is an area corresponding to J, the amount of requested electric energy at the area is 2.18 [W], and the length of the heating element 7253 is 1419.83 mm. The length of the heating element 7253 according to the requested electric energy may vary proportionally depending on the thickness or width of the heating element 7253. In order to increase the length of the heating element 7253 within a certain distance, as seen above, the length of the heating element 7253 may be increased by increasing the density of the heating element 7253 within the certain distance.

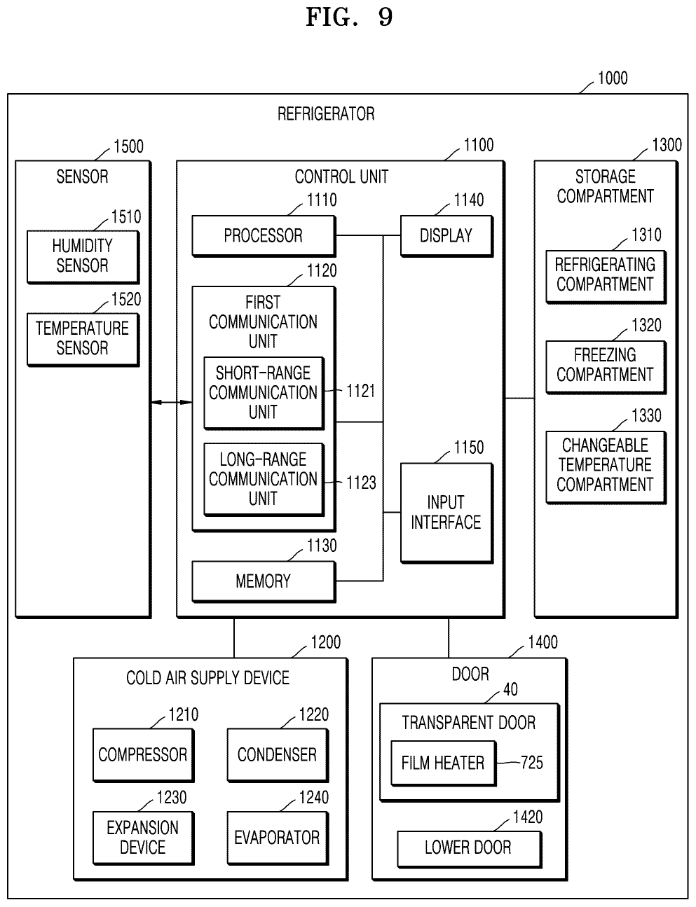

FIG. 9 is a block diagram of a refrigerator according to one or more embodiments of the present disclosure.

Referring to FIG. 9, a refrigerator 1000 according to the present disclosure may include a control unit 1100, a cold air supply device 1200, a storage compartment 1300, a door 1400, and a sensor 1500.

The cold air supply device 1200 may include a compressor 1210, a condenser 1220, an expansion device 1230, and an evaporator 1240, which are capable of driving a refrigeration cycle. According to one or more embodiments, the cold air supply device 1200 may further include a semiconductor, such as a thermoelectric element. The thermoelectric element may cool the storage compartment 1300 by heating and cooling operations through a Peltier effect. The storage compartment 1300 may include a refrigerating compartment 1310, a freezing compartment 1320, and a changeable temperature compartment 1330, and the changeable temperature compartment 1330 may or may not be included depending on the design specifications of the refrigerator 1000. The refrigerating compartment 1310, the freezing compartment 1320, and the changeable temperature compartment 1330 of the storage compartment 1300 may also be referred to as various names, such as a “vegetable compartment,” a “fresh compartment,” a “cooling compartment,” and an “ice making compartment.” The terms “refrigerating compartment,” “freezing compartment,” and “changeable temperature compartment” as used herein should be understood as encompassing the storage compartments having the corresponding purposes and temperature ranges.

The door 1400 is used to allow the user to put food stored in the storage compartment 1300 in the refrigerator 1000 and take food out of the refrigerator 1000 while preserving the coldness of the storage compartment 1300 of the refrigerator 1000. In the case of an SBS-type, the door 1400 may include two doors that open on both sides and may be divided into a transparent door 40 and a lower door 1420. In FIG. 9, a case where the transparent door 40 is an upper door is merely an example, but the lower door 1420 may be the transparent door. According to one or more embodiments of the present disclosure, a film heater 725 may be attached onto the transparent door 40, and the film heater 725 may prevent dew formation on the transparent door 40.

The control unit 1100 may include a processor 1110, a first communication unit 1120, a memory 1130, a display 1140, and an input interface 1150.

The processor 1110 included in the control unit 1100 may be implemented as one or more processors. In addition, an artificial intelligence (AI) processor may be mounted on the processor 1110. The AI processor may be manufactured in the form of a dedicated hardware chip for AI, or may be manufactured as part of an existing general-purpose processor (e.g., central processing unit (CPU) or application processor) or a graphics processing unit (GPU) and mounted on the refrigerator 1000.

The processor 1110 may control the first communication unit 1120, the display 1140, and the memory 1130 by executing programs stored in the memory 1130. According to one or more embodiments of the present disclosure, the processor 1110 may be an AI processor. The AI processor may be manufactured in the form of a dedicated hardware chip for AI, or may be manufactured as part of an existing general-purpose processor (e.g., CPU or application processor) or a GPU and mounted on the refrigerator 1000. For example, the processor 1110 may receive temperature information of the storage compartment from a temperature sensor 1520 and generate a cooling control signal for controlling the operation of the cold air supply device, based on the temperature information of the storage compartment. The processor 1110 may receive a user input from the input interface 1150 and transmit, to the display 1140, a display control signal and image data for displaying an image on the display 1140 in response to the user input. In one or more embodiments, the processor 1110 may sense the degree of dew formation on the door 1400 by using the humidity sensor 1510 and, when it is determined that the humidity is higher than a certain value (i.e. threshold level), may perform control to remove dew formed on the door 1400, including the transparent door 40, by turning on power applied to the film heater 725. The processor 1110 may receive a dew removal command from a user through the input interface 1150 and perform control to remove dew formed on the door 1400 by turning on power applied to the film heater 725.

The processor 1110 may control the display 1140 to display information or notifications, such as the state or errors of the refrigerator 1000, to the user. The first communication unit 1120 may include one or more components that enable communication between the refrigerator 1000 and a server device or between the refrigerator 1000 and a mobile device. For example, the first communication unit 1120 may include a short-range communication unit 1121, a long-range communication unit 1123, etc.

The short-range communication unit 1121 may include a Bluetooth communication unit, a Bluetooth Low Energy (BLE) communication unit, a Near Field Communication (NFC) unit, a wireless local area network (WLAN) (Wireless Fidelity (Wi-Fi)) communication unit, a Zigbee communication unit, an Infrared Data Association ((IrDA) communication unit, a Wi-Fi Direct (WFD) communication unit, an ultra wideband (UWB) communication unit, an Ant+ communication unit, etc. The long-range communication unit 1123 may be used to communicate with a server device when the refrigerator 1000 is remotely controlled by the server device in an IoT environment. The long-range communication unit 1123 may include the Internet, a computer network (e.g., a local area network (LAN) or a wide area network (WAN)), and a mobile communication unit. The mobile communication unit may include a 3rd generation (3G) module, a 4th generation (4G) module, a 5th generation (5G) module, a long term evolution (LTE) module, an NB-IoT module, and an LTE-M module, but the present disclosure is not limited thereto.

The display 1140 is used to display required data.

When the display 1140 and a touch pad are configured as a touch screen having a layer structure, the display 1140 may also be used as an input device. The display 1140 may include at least one of liquid crystal display, thin-film transistor-liquid crystal display, light-emitting diode (LED), organic LED, flexible display, three-dimensional (3D) display, or electrophoretic display. According to the implementation of the refrigerator 1000, the refrigerator 1000 may include two or more displays 1140.

The input interface 1150 receives an input from the user. The input interface 1150 may be at least one of a key pad, a dome switch, a touch pad (a contact capacitance type touch pad, a pressure resistance film type touch pad, an infrared detection type touch pad, a surface ultrasonic conduction type touch pad, an integral tension measurement type touch pad, a piezo effect type touch pad, etc.), a jog wheel, or a jog switch, but the present disclosure is not limited thereto.

The input interface 1150 may include a voice recognition module. For example, the refrigerator 1000 may receive a voice signal, which is an analog signal, through a microphone, and convert the voice part into computer-readable text by using an automatic speech recognition (ASR) model. In addition, the refrigerator 1000 may receive a voice signal through a microphone and output the voice through a speaker provided in the refrigerator itself. The refrigerator 1000 may obtain a user's utterance intention by interpreting the text by using a natural language understanding (NLU) model. The ASR model or the NLU model may be an AI model. The AI model may be processed by an dedicated AI processor designed with a hardware structure specialized for processing the AI model. The AI model may be made through machine learning. The expression “being made through learning” means that the AI model or the predefined operation rule configured to perform desired characteristics (or purposes) is made in such a manner that a basic AI model is trained by using a large number of training data by a learning algorithm. The AI model may include a plurality of neural network layers. Each of the neural network layers has a plurality of weight values and performs neural network operations through operations between the plurality of weight values and an operation result of a previous layer.

Linguistic understanding is a technology that recognizes, applies, and processes human language and characters, and may include natural language processing, machine translation, dialog system, question answering, and speech recognition/synthesis, and the like.

The memory 1130 may store a program for processing and controlling the processor 1110) and may also store input/output data. The memory 1130 may also store the AI model. For example, the memory 1130 may store an AI model for sound recognition, an AI model for sound output, etc. The memory 1130 may store programs and/or data for controlling the components included in the refrigerator 1000 and may store temporary data generated during the process of generating a control signal for controlling the components included in the refrigerator.

The memory 1130 may include at least one type of storage medium selected from flash memory-type memory, hard disk-type memory, multimedia card micro-type memory, card-type memory (e.g., secure digital (SD) or extreme digital (XD) memory), random access memory (RAM), static random access memory (SRAM), read-only memory (ROM), electrically erasable programmable read-only memory (EEPROM), programmable read-only memory (PROM), magnetic memory, magnetic disc, and optical disc. In addition, the refrigerator 1000 may operate a web storage or a cloud server that performs a storage function on the Internet.

In one or more embodiments, the sensor 1500 may include a humidity sensor 1510 and a temperature sensor 1520. The temperature sensor 1520 may sense the temperature of the storage compartment 1300 and transmit temperature information to the processor 1110. The processor 1110 may control the temperature of the storage compartment 1300 of the refrigerator 1000 by controlling the cold air supply device 1200 based on the transmitted temperature information. The humidity sensor 1510 may sense the humidity of each part of the refrigerator 1000 and transmit humidity information to the processor 1110. The processor 1110 may remove humidity generated in the refrigerator 1000 based on the received humidity information. In one or more embodiments, the processor 1110 may remove humidity by controlling electric energy input to the film heater 725 based on humidity information generated in the door 1400, particularly the door including the transparent door. In one or more embodiments, the processor 1110 may perform control to increase the magnitude of power applied to the film heater 725 when the humidity generated based on the sensed humidity information is high. For example, the processor 1110 may perform control so that the total power applied to the film heater 725 is 22 [W]. In one or more embodiments, the processor 1110 may perform control so that the magnitude of power applied to the film heater 725 is at an intermediate level when the humidity generated based on the sensed humidity information is at an intermediate level. For example, the processor 1110 may perform control so that the total power applied to the film heater 725 is input as much as 14 [W]. In one or more embodiments, the processor 1110 may perform control to decrease the magnitude of power applied to the film heater 725 when the humidity generated based on the sensed humidity information is low. For example, the processor 1110 may perform control so that the total power applied to the film heater 725 is input as much as 8 [W].

The method according to one or more embodiments of the present disclosure may be implemented in the form of program commands that are executable through a variety of computer means and may be recorded on a computer-readable recording medium. The computer-readable storage medium may include program commands, data files, data structures, etc. alone or in combination. The program commands recorded on the computer-readable storage medium may be specially designed and configured for the present disclosure or may be known and available to those of ordinary skill in the art of computer software. Examples of the computer-readable recording medium may include magnetic media, such as hard disk, floppy disk, and magnetic tape, optical media, such as compact disc read-only memory (CD-ROM) and digital versatile disc (DVD), magneto-optical media, such as floptical disk, and hardware devices specially configured to store and execute program commands, such as ROM, RAM, and flash memory. Examples of the program commands may include not only machine language code generated by a compiler but also high-level language code that is executable using an interpreter by a computer.

One or more embodiments of the present disclosure may also be implemented in the form of a recording medium including commands executable by a computer, such as a program module executed by a computer. A computer-readable recording medium may be any available media that are accessible by the computer and may include any volatile and non-volatile media and any removable and non-removable media. In addition, the computer-readable recording medium may include a computer storage medium and a communication medium. The computer-readable storage medium may include any volatile, non-volatile, removable, and non-removable media that are implemented in any method or technology for storage of information, such as computer-readable instructions, data structures, program modules, or other data. The communication medium may typically include computer-readable instructions, data structures, program modules, other data of a modulated data signal, such as carriers, or other transmission mechanisms, and may include any information delivery medium. In addition, the present disclosure may be implemented as a computer program or a computer program product, which includes instructions executable by a computer, such as a computer program executed by a computer.

A machine-readable storage medium may be provided in the form of a non-transitory storage medium. The ‘non-transitory storage medium’ is a tangible device and only means not including a signal (e.g., electromagnetic waves). This term does not distinguish between a case where data is semi-permanently stored in a storage medium and a case where data is temporarily stored in a storage medium. For example, the ‘non-transitory storage medium’ may include a buffer in which data is temporarily stored.

A method according to one or more embodiments may be provided by being included in a computer program product. The computer program product may be traded between a seller and a buyer as commodities. The computer program product may be distributed in the form of a machine-readable storage medium (e.g., compact disc read-only memory (CD-ROM)), or may be distributed (e.g., downloaded or uploaded) online either via an application store or directly between two user devices (e.g., smartphones). In the case of the online distribution, at least a part of a computer program product (e.g., downloadable app) is stored at least temporarily on a machine-readable storage medium, such as a server of a manufacturer, a server of an application store, or memory of a relay server, or may be temporarily generated.

While the disclosure has been illustrated and described with reference to one or more embodiments, it will be understood that the one or more embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiments described herein may be used in conjunction with any other embodiments described herein.

What is claimed is:

1. A refrigerator comprising:
a main body comprising a storage compartment;
a door coupled to the main body and configured to open and close the storage compartment, at least a portion of the door being transparent; and
a film heater attached to the door,
wherein the film heater comprises a heating-element heating wire configured to emit heat, and
wherein the heating-element heating wire is within 1 mm to 7 mm from an end of the film heater.

2. The refrigerator of claim 1, wherein the door is a transparent glass door or a transparent plastic door.

3. The refrigerator of claim 1, wherein the film heater is attached to an edge of the door.

4. The refrigerator of claim 3, wherein the film heater is attached to the edge of the door such that the heating-element heating wire directly contacts the edge of the door.

5. The refrigerator of claim 3, wherein an amount of the heating-element heating wire of the film heater is more densely arranged in an area of the edge of the door in a location in which a humidity level of the door is high than in a location in which the humidity level of the door is low.

6. The refrigerator of claim 5, further comprising:
a humidity sensor configured to sense the humidity level of the door; and
a processor configured to control the heating-element heating wire of the film heater in a state in which the humidity level of at least the portion of the door sensed by the humidity sensor is greater than a threshold level.

7. The refrigerator of claim 6, wherein the processor is further configured to control a magnitude of electric energy supplied to the film heater according to the humidity level sensed by the humidity sensor.

8. The refrigerator of claim 1, wherein the film heater comprises a first insulating film on a first surface of the film heater.

9. The refrigerator of claim 8, wherein the first insulating film comprises an adhesive material configured to adhere to the door.

10. The refrigerator of claim 8, wherein the film heater comprises a second insulating film on a second surface of the film heater opposite to the first surface, the heating-element heating wire being between the first insulating film and the second insulating film.

11. The refrigerator of claim 1, wherein a thickness of the film heater is 600 micrometers or less.

12. The refrigerator of claim 3, wherein the heating-element heating wire is arranged on the door in a left and right zigzag shape vertically to a longitudinal direction of the edge of the door, and
wherein an amount of the heating-element heating wire is more densely arranged in an area in which a humidity level of the door is high than in an area in which the humidity level of the door is low.

13. The refrigerator of claim 3, wherein the heating-element heating wire is arranged on a frame of the door in a longitudinal direction of the edge of the door, and
wherein an amount of the heating-element heating wire is more densely arranged in an area in which a humidity level of the door is high than in an area in which the humidity level of the door is low.

14. The refrigerator of claim 1, wherein the heating-element heating wire is within 4 mm to 5 mm from the end of the film heater.
